(19) United States
(12) Patent Application Publication
(10) Pub. No.: US 2025/0224501 A1
(43) Pub. Date: Jul. 10, 2025

(54) LOCATION METHODS FOR FREQUENCY MODULATION CONTINUES WAVE (FMCW) RADAR AND COMMUNICATION DEVICES

(71) Applicant: KOREA ADVANCED INSTITUTE OF SCIENCE AND TECHNOLOGY, Daejeon (KR)

(72) Inventors: Song Min KIM, Daejeon (KR); Kangmin BAE, Daejeon (KR); Hankyeol MOON, Daejeon (KR)

(21) Appl. No.: 19/004,643

(22) Filed: Dec. 30, 2024

Related U.S. Application Data
(63) Continuation-in-part of application No. PCT/KR2024/000233, filed on Jan. 4, 2024.

(30) Foreign Application Priority Data
Jan. 4, 2024 (KR) 10-2024-0001692

(51) Int. Cl. G01S 13/34; G01S 7/35; G01S 7/40

(52) U.S. Cl. CPC G01S 13/343; G01S 7/35; G01S 7/4056

(57) ABSTRACT

In an existing method of measuring a location of a communication device by using FMCW radar, a frequency reflected from the communication device is used, and a method of calculating a difference between a frequency of a transmission signal of the FMCW radar and a frequency of a reflect wave reflected from the communication device is used. However, in the process of identifying the frequency difference, frequency difference is measured with a frequency resolution a reciprocal of a unit chirp time length, and the exact frequency cannot be measured.

The present disclosure is to solve the above problem, and provides
the effect of quickly and accurately measuring a distance between an FMCW radar and a communication device by using the FMCW radar and a frequency modulation tag, by transmitting a continuous chirp signal from the FMCW radar, simultaneously calculating an intermediate signal (IF), which is the frequency difference between transmitted and received signal, and demodulating the accurate modulation frequency f_m.

### TECHNICAL FIELD

The present disclosure relates to technology for precisely measuring a location by using a communication device. More specifically, it relates to technology for improving the positioning accuracy of a communication device by utilizing signal processing technology.

### BACKGROUND ART

Prior to the filing of the present disclosure, technology relating to an interrogator and a communication device comprising the same was disclosed. This technology discloses a technology including: an interrogator that outputs an interrogation signal consisting of a series of unit chirp signals varying from a first frequency to a second frequency; and a backscatter tag that receives the interrogation signal, modulates the frequency thereof, and forms and provides a tag signal.

Disclosed in other prior art are a method and device for performing communication based on backscattering in wireless communication system. This technology discloses a technology including: an interrogator that outputs an interrogation signal consisting of a series of unit chirp signals varying from a first frequency to a second frequency; and a backscatter tag that receives the interrogation signal, modulates the frequency thereof, and forms and provides a tag signal, wherein the interrogator receives the tag signal and modulates the tag signal.

### DISCLOSURE OF INVENTION

### Technical Problem

In the existing method of measuring a location of a communication device using an FMCW radar, a frequency reflected from the communication device is used, and a method of calculating a difference in frequency between a transmission signal of the FMCW radar and a reflect wave reflected from the communication device is used. However, in the process of identifying the frequency difference, the frequency difference is measured with a frequency resolution the reciprocal of the unit chirp time length, and the exact frequency cannot be measured. For this reason, errors may occur in distance measurement by the communication device because the identification resolution of the frequency difference is limited.

The present disclosure seeks to eliminate distance measurement errors between an FMCW radar and a communication device, which occur due to inability to accurately measure the difference in frequency as described above.

The communication device may include either an active frequency modulation tag having a receiving antenna and a transmitting antenna that are equipped with a power source and modulate a received signal and generate a reflect signal, or a passive frequency modulation tag that receives a radar signal, modulates the signal, and reflects the signal.

In the present disclosure, a frequency modulation tag is used as the same term as the communication device.

In addition, the FMCW radar may be composed of a signal generator that generates various types of transmission signals, a transmitting antenna that transmits the generated signals, a receiving antenna that receives the signals, and a signal processing unit. In some cases, the signal generator and the transmitting antenna, and the receiving antenna that receives the signals and the signal processing unit may be provided separately.

### Solution to Problem

The configuration of the disclosure to solve the above problem is as follows.

Provided is a method of, by using an FMCW radar and frequency modulation tags,
measuring a location of a communication device by using an FMCW radar, the method including transmitting, by the FMCW radar, a continuous chirp signal and simultaneously calculating an intermediate signal (IF) which is the frequency difference between the signal transmitted and received by the FMCW radar, wherein a tag signal which is an intermediate signal of a reflect wave which is continuous chirp signal reflected by the frequency modulation tag is the sum of a modulation frequency f_m and a range frequency f_r which represents a distance due to a time shift, calculating the modulation frequency f_m by, in order to calculate the modulation frequency f_m of the tag signal from the FMCW radar, subtracting from a maximum peak frequency of the tag signal modulated from the frequency modulation tag located between ambient reflection signals located at frequencies which are integer multiples of the reciprocal of a unit chirp time length in frequency domain to a frequency of a nearest ambient reflection signal smaller than the maximum peak frequency.

Also, provided is a method of, by using an FMCW radar and a frequency modulation tag,
measuring a location of a communication device by using an FMCW radar, the method including a method of calculating, a range frequency indicating a distance between the FMCW radar and the frequency modulation tag from a tag signal transmitted from the frequency modulation tag, the method including demodulating a sinc function of the tag signal received from the frequency modulation tag by using modulation frequency spectrum leakage feature values of the tag signal received from the frequency modulation tag, which does not overlap with ambient reflection signal frequencies periodically positioned with respect to a maximum peak frequency of a signal, modulated by the frequency modulation tag, positioned between the ambient reflection signal frequencies positioned periodically in the frequency domain, and calculating the range frequency by subtracting the modulation frequency from a center frequency of the demodulated sinc function.

Also, provided is a method of, by using the FMCW radar and the frequency modulation tag,
measuring a location of a communication device, using an FMCW radar, the method including a method of measuring a distance between an FMCW radar and a frequency modulation tag, the method including:
a radar transmission signal generation operation of generating, by the FMCW radar, a radar transmission signal; and
a reflect wave transmission operation of receiving, by a tag receiving antenna provided in the frequency modulation tag, the radar transmission signal generated in the radar transmission signal generation operation, modulating frequency by f_m, by a modulation unit provided in the frequency modulation tag, and transmitting the modulated signal, by a tag transmission antenna of the frequency modulation tag; and
a signal receiving operation of receiving, by a receiving antenna provided in the FMCW radar, the modulated signal transmitted in the reflect wave transmission operation; and
a received frequency preprocessing operation of generating an intermediate signal by mixing a frequency transmitted from the FMCW radar and a frequency received by the FMCW radar, in order to calculate a sum of a range frequency and a modulation frequency, which is a difference between the frequency transmitted from the FMCW radar and the frequency received in the signal receiving operation; and
a frequency domain conversion operation of converting an intermediate signal generated in the received frequency preprocessing operation into a frequency domain; and
a separated frequency identification operation of identifying ambient reflection signal frequency that is periodically located in the frequency domain of the intermediate signal, which was converted in the frequency domain conversion operation, and a tag signal modulated in the frequency modulation tag; and
calculating the modulation frequency f_m by subtracting, from a maximum peak frequency of the tag signal modulated in the frequency modulation tag, a nearest ambient reflection signal frequency smaller than a maximum peak frequency of the tag signal, between the ambient reflection signals located periodically.

Also, provided is a method of, by using the FMCW radar and the frequency modulation tag,
measuring a location of a communication device, using an FMCW radar, the method including a method of measuring a distance between an FMCW radar and a frequency modulation tag, the method including:
a radar transmission signal generation operation of generating, by the FMCW radar, a radar transmission signal; and
a reflect wave transmission operation of receiving, by a tag receiving antenna provided in the frequency modulation tag, the radar transmission signal generated in the radar transmission signal generation operation, modulating frequency by f_m, by a modulation unit provided in the frequency modulation tag, and transmitting the modulated signal, by a tag transmission antenna of the frequency modulation tag; and
a signal receiving operation of receiving, by a receiving antenna provided in the FMCW radar, the modulated signal transmitted in the reflect wave transmission operation; and
a received frequency preprocessing operation of generating an intermediate signal by mixing a frequency transmitted from the FMCW radar and a frequency received by the FMCW radar, in order to calculate a sum of a range frequency and a modulation frequency, which is a difference between the frequency transmitted from the FMCW radar and the frequency received in the signal receiving operation; and
a frequency domain conversion operation of converting an intermediate signal generated in the received frequency preprocessing operation into a frequency domain; and
a separated frequency identification operation of identifying ambient reflection signal frequency periodically located in the frequency domain of the intermediate signal, which is converted in the frequency domain conversion operation, and a tag signal modulated in the frequency modulation tag; and
demodulating a sinc function of the tag signal received from the frequency modulation tag by using modulation frequency spectrum leakage feature values of a tag signal received from a frequency modulation tag that does not overlap with the ambient reflection signal frequencies that are periodically positioned, with respect to a maximum peak frequency of the signal modulated from the frequency modulation tag, and calculating a center frequency of the demodulated sinc function as a sum of the range frequency and the modulation frequency.

In addition, provided is a method of measuring the location of a communication device using an FMCW radar, wherein a value obtained by subtracting the modulation frequency (f_m) from the center frequency in the frequency domain is calculated as the range frequency f_r indicating the distance.

In addition, provided is a method of measuring a location of a communication device using an FMCW radar, wherein a radar signal generated from the FMCW radar includes any one of a periodic repetition of two or more chirp signals, an intermittent periodic repetition of two or more chirp signals, a discontinuous periodic repetition of two or more chirp signals, and a discontinuous and intermittent periodic repetition of two or more chirp signals.

In addition, provided is a method of measuring location of a communication device using an FMCW radar, wherein the distance between the FMCW radar and the frequency modulation tag is calculated by multiplying the speed of light to time delay according to distance calculated by a reciprocal of the f_r.

### Advantageous Effects of Invention

According to the configuration of the disclosure as described above, the present disclosure has the effect of providing a technology whereby a distance between an FMCW radar and a single or multiple stationary or moving frequency modulation tags having a frequency modulation function may be quickly and accurately measured using the FMCW radar and the frequency modulation tags having a frequency modulation function.

### BRIEF DESCRIPTION OF DRAWINGS

FIG. 1 is a conceptual diagram and an internal configuration diagram of an FMCW radar and a communication device (tag, frequency modulation tag) of the present disclosure.

FIG. 2 is a configuration diagram of an FMCW radar and a plurality of communication devices (tags) of the present disclosure.

FIG. 3 is a signal graph of communication signals, in a time domain, used in an FMCW radar and a plurality of communication devices of the present disclosure.

FIG. 4 shows types of signals (chirp signals and modulated signals thereof) that may be used for distance measurement in an FMCW radar of the present disclosure.

FIG. 5 is a graph of comparison, in a frequency domain, between results of intermediate signal reception using a conventional FMCW radar and a frequency modulation tag and results of intermediate signal reception using an FMCW radar and a frequency modulation tag that use a continuous chirp signal of the present disclosure.

FIG. 6 is a graph for calculating a modulation frequency f_m of a frequency modulation tag, by illustrating, in a frequency domain, a tag signal of the frequency modulation tag received by an FMCW radar of the present disclosure.

FIG. 7 is a graph of demodulating a sinc function graph of a frequency modulation tag received signal by using spectrum leakage feature points that display, in a frequency domain, a tag signal of a frequency modulation tag received by an FMCW radar of the present disclosure.

FIG. 8 is a diagram describing a sequence of signal processing of a tag signal of a frequency modulation tag received by an FMCW radar of the present disclosure.

FIG. 9 is a conceptual diagram for measuring distances of a plurality of frequency modulation tags from an FMCW radar by using the FMCW radar and the plurality of frequency modulation tags of the present disclosure.

FIG. 10 is a diagram illustrating measurement of locations of a plurality of tags on a plane by using an FMCW radar and a plurality of frequency modulation tags of the present disclosure.

FIG. 11 is a graph showing results of calculating a sinc function of individual tag signals to measure locations of a plurality of tags on a plane by using an FMCW radar and a plurality of frequency modulation tags of the present disclosure.

FIG. 12 is an explanatory diagram of a case where a frequency modulation tag is fixed attached to a moving object and a case where a frequency modulation tag is attached to a stationary object, by using an FMCW radar and two frequency modulation tags of the present disclosure.

FIG. 13 is a graph showing a tag signal in a frequency domain when a frequency modulation tag of the present disclosure is attached to a moving object.

FIG. 14 is an explanatory diagram of a case where a frequency modulation tag is attached to a moving object and a case where a frequency modulation tag is attached to a stationary object by using an FMCW radar and a plurality of frequency modulation tags of the present disclosure.

FIG. 15 is an explanatory diagram illustrating signals exchanged when measuring a distance between an FMCW radar and a frequency modulation tag by using the FMCW radar and one frequency modulation tag of the present disclosure.

FIG. 16 is an embodiment for detecting a location of a frequency modulation tag in 2D or 3D space.

FIG. 17 is another embodiment for detecting a location of a frequency modulation tag in 2D or 3D space.

FIG. 18 is another embodiment of the present disclosure for simultaneously detecting stationary and moving frequency modulation tags in 2D or 3D space.

### BEST MODE FOR CARRYING OUT THE INVENTION

The operational effects generated by the configuration of the present disclosure are explained using the drawings as follows.

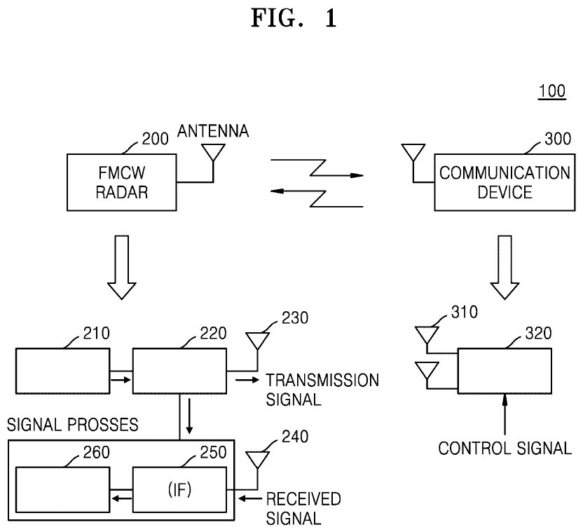

FIG. 1 is a conceptual diagram and an internal configuration diagram of an FMCW radar and a communication device (tag, frequency modulation tag) of the present disclosure. The upper figure illustrates the concept of an FMCW radar and a communication device exchanging signals with each other, and the lower figure illustrates the configuration of the FMCW radar and the communication device. An FMCW radar includes a transmitter for transmitting a signal to the communication device, a receiver for receiving a signal reflected from the communication device, and a location measurement algorithm for calculating location information from the received signal. The communication device may include a transmitting/receiving antenna and a modulation unit, and may further include a separate control signal to control the modulation unit, and the transmitting/receiving antenna may be separated and configured as a transmitting antenna and a receiving antenna. An FMCW radar may use various types of chirp signals, and for this purpose, includes a chirp signal generator, and the generated chirp signal is transmitted through a splitter and a transmitting antenna. A transmission signal transmitted to a mixer through the splitter is multiplied by the received signal received through a receiving antenna in the mixer to generate an intermediate signal (IF). The generated IF signal is converted into a signal in a frequency domain and separated into an ambient reflection signal (noise signal) and a communication device signal (tag signal). The communication device signal separated as above is used to accurately measure a location of the communication device by demodulating a sinc function of the communication device signal by using a spectrum leakage characteristic frequency. The communication device may be any device that consists of a receiving antenna, a modulation unit, and a transmitting antenna, and it is even more convenient if the communication device is in the form of a tag that may be simply attached and used. In the present disclosure, a tag may be used as the same expression as the communication device, but in order to distinguish the same from a tag without a general frequency modulation function, a frequency modulation tag may also be used to indicate the same meaning.

For frequency modulation, a modulation unit of the tag modulates by repeatedly switching between two or more impedance values. The modulation unit may switch an impedance value according to a value of a control signal input from an external source, and various means may be used to adjust a control signal, such as an output of a voltage-controlled oscillator (VCO), switching between multiple fixed oscillators, or direct generation from a separate processor (such as an MCU).

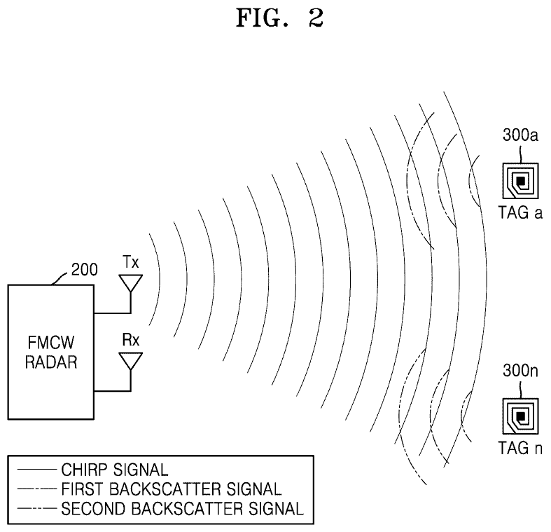

FIG. 2 is a configuration diagram of an FMCW radar and a plurality of communication devices (tags) of the present disclosure. A plurality of frequency modulation tags that have received a radar chirp signal generated by FMCW each reflect a frequency that is modulated differently for each tag, and this reflect signal is received by the FMCW radar to separate and identify each tag, and calculates a distance for each tag.

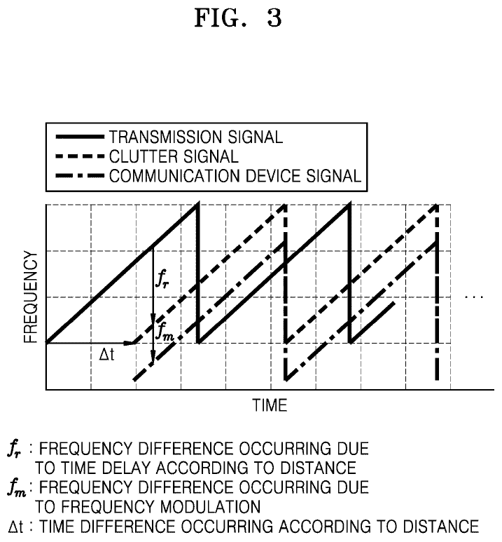

FIG. 3 is a signal graph, in time domain, of a communication device reflect wave received from an FMCW radar of the present disclosure. A signal generated by the FMCW radar is reflected by objects, buildings, and things existing in space and is received by the FMCW radar with a certain time delay (dt). A reflect signal of the communication device (frequency modulation tag) undergoes internal frequency conversion and is received by the FMCW radar at a distance from object, building, and thing signals by a modulated frequency signal. However, since it is a time domain, it is seen that multiple signals may be measured while overlapping each other on the X-axis representing the same time. However, since the Y-axis values of respective frequencies represent do not overlap, these signals may be measured separately in a frequency domain.

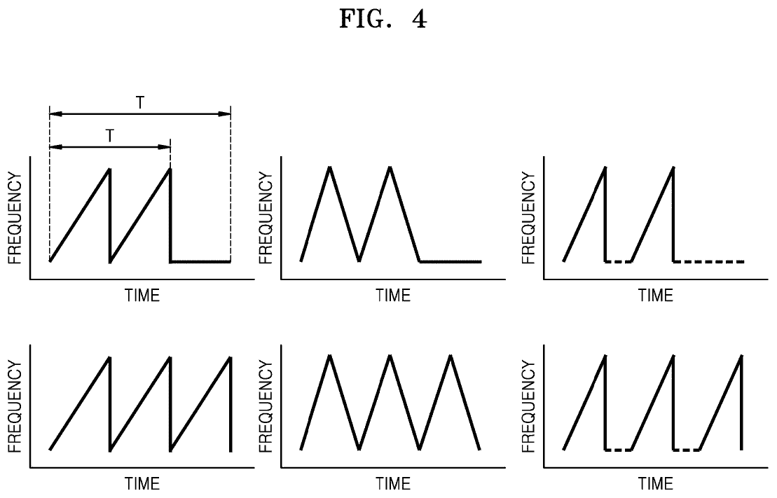

FIG. 4 illustrates types of signals (chirp signals and modulated signals thereof) that may be used for distance measurement in an FMCW radar of the present disclosure. A chirp signal is a signal having a frequency changing linearly over time. The frequency needs not change linearly over the entire period, and may repeat periodically, and the increasing and decreasing portions thereof may or may not be symmetrical. FIG. 4 illustrates various forms of chirps that may be used partially or fully. According to the present disclosure, chirp signals of other forms than those shown in FIG. 4 may be used as needed, and signals may be generated and used as needed, by discontinuously repeating or continuously repeating or continuously discontinuously repeating or discontinuously discontinuously repeating. These signals may be used periodically and repeatedly over a period of time. In FIG. 4, a continuous chirp signal may vary the number of chirps and a time length of the chirps. As the number of chirps increases, the frequency resolution increases, allowing for larger number of tags to be operated. As the chirp length increases, tags may be observed at longer distances. On the other hand, reducing the number and length of chirps allows a tag's location information to be updated at a faster rate. Depending on the application environment of the technology, an appropriate continuous chirp signal setting may be selected.

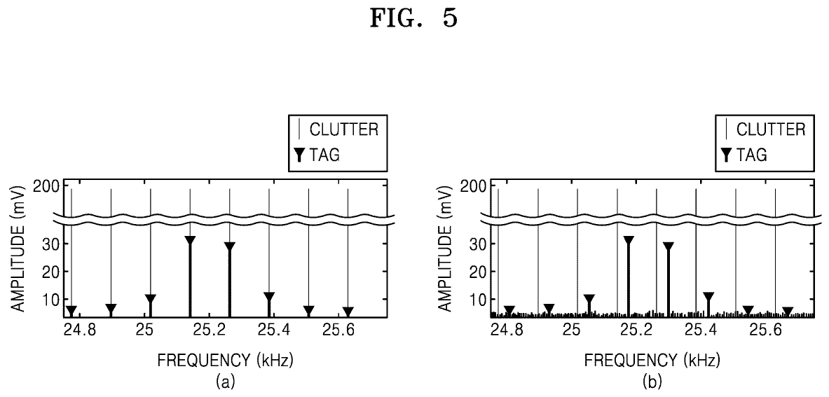

FIG. 5 is a graph of comparison, in a frequency domain, between results of intermediate signal reception using a conventional FMCW radar and a frequency modulation tag and results of intermediate signal reception using an FMCW radar and a frequency modulation tag that use a continuous chirp signal of the present disclosure. (a) of FIG. 5 shows that a communication device signal that undergoes 40 Hz frequency-modulation is represented in the same frequency as the ambient reflection signals (noise) generated by nearby surrounding objects (clutter) in the FMCW radar, and the signal size is small and cannot be recognized. (b) A communication device signal that undergoes 40 Hz frequency-modulation is represented separately from the ambient reflection signal under a continuous chirp interrogation method. Here, distance accuracy of the communication device follows the same as that of the existing FMCW radar, 2BW/C (60 cm for the 250 MHz frequency band).

A continuous chirp radar transmission method with continuous chirp signal processing added to an FMCW radar effectively separates a tag FSK signal from the ambient reflection signals in the frequency domain.

Compared to the conventional FMCW that uses an intermittent single chirp signal c(t), the continuous chirp interrogation method utilizes a radar transmission signal as a multiple continuous chirp signal.

$$s ( t ) = c ( t ) * {\sum }_{n = 1}^{N} δ ( t - n T )$$

Here, c(t) represents a single chirp, T represents a chirp duration, N represents the number of chirp repetitions, and * represents convolution. That is, s(t) is a signal in the lower left of FIG. 5, which is a signal in which the chirp c(t) is repeated N times with a period T.

When this radar transmission signal reflects from an ambient reflector (i.e., clutter), propagation delay is reflected as s(t−dt), where dt is a round-trip propagation delay time between the radar and the clutter. In the continuous chirp interrogation method, the radar transmission signal reflected from the clutter is received simply as time-shifted radar transmission signal, and thus maintains the period T. Therefore, the radar intermediate signal (IF) of a clutter (ambient reflection signal, measurement noise) is represented by a peak of integer multiples of 1/T Hz frequency (since a signal with the period T is represented as a sum of integer multiples of 1/T Hz frequency), and all other frequency components that are not the integer multiples of 1/T Hz will be zero. This applies to all clutter noise, i.e. all noise is concentrated in the same set of frequencies.

On the other hand, a reflect signal reflected by a communication device (backscatter signal, communication device signal) has a period that is changed by FSK (Frequency Shift Keying) from the FMCW radar transmission signal. Specifically, a signal reflected from the communication device is expressed by the following equation.

$$s ( t - dt ) * {e}^{j 2 π fmt}$$

$$Interrogation signal * FSK$$

$$( period T ) ( period 1 / fm )$$

Here, f_m is a modulation frequency of FSK, and a period thereof is 1/f_m, which is different from the period T of the FMCW radar chirp signal. As a result, the period of the communication device signal is the least common multiple of T and 1/f_m, which is a new period other than T. As a result of this frequency modulation, a reflect wave of the communication device is represented in a frequency that is not an integer multiple of 1/T during a process of being converted into an intermediate signal, and is thus displayed separated from clutter noise in the frequency domain. The separation between the communication device signal and clutter (ambient reflection signals, noise) is shown in FIG. 5.

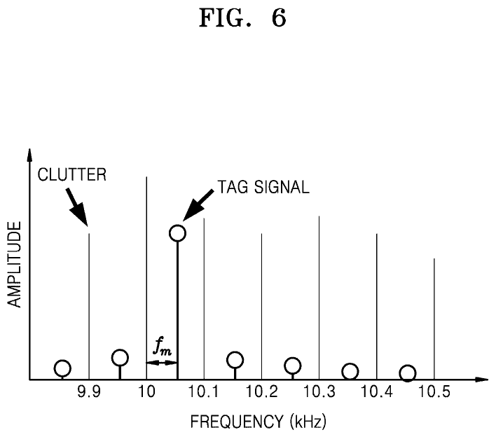

FIG. 6 is a graph for calculating a modulation frequency f_m of a frequency modulation tag, by illustrating, in a frequency domain, an FMCW radar and a frequency modulation tag received signal of the present disclosure. The frequency modulation tag received signal is a signal that includes a frequency change f_r due to time delay and a frequency change f_m due to frequency modulation performed within the frequency modulation tag. Therefore, if the frequency difference f_m due to frequency modulation is calculated, the frequency change f_r due to time delay may be calculated and a distance may be calculated using the same.

The first step to obtain an accurate estimate of the range frequency f_r, that is, the frequency change due to time delay, is to remove the influence of f_m from the intermediate frequency (IF, Intermediate Frequency) signal. Although the modulation frequency may be designated when designing a communication device, in reality, f_m is not always constant due to the instability of an oscillator, and thus needs to be measured in real time to be used. For example, a crystal oscillator has a deviation of approximately 500 ppm in various environments, and even when configuring an oscillator circuit with an LCR circuit, changes occur depending on the temperature. Thus, when calculating f_r by simply using designated f_m frequency without actual measurement, a large distance error of 24.6 cm or more was measured.

According to a location measurement method of the present disclosure, f_m may be accurately measured by the following method without prior knowledge of the modulation frequency of the communication device or the environment in which the communication device is installed. To accurately identify f_m, f_r may be measured using the principle of using a multi-chirp signal (s(t−dt)) with a propagation delay caused by the distance difference between the FMCW radar and the communication device, that is, the period T. f_m is an FSK signal of e^{j2πfmt}, which has a period of 1/f_m, and the s(t−dt) signal is frequency-shifted by f_m. Due to this frequency shift, the intermediate signal (IF) of the communication device signal is displayed at a frequency f_m away from frequency peaks of an integer multiples of 1/T Hz, as shown in FIG. 6. Therefore, f_m may be accurately calculated in real time through the frequency difference from the peaks of integer multiples of 1/T Hz, adjacent to the communication device signal.

To remove f_m, first the clutter noise is nullified to 0, and then the communication device signal is shifted to the nullified frequency range, from which f_m is removed. This is because, by removing f_m from the communication device signal, a signal is positioned at the integer multiple of 1/T Hz where the clutter noise is present.

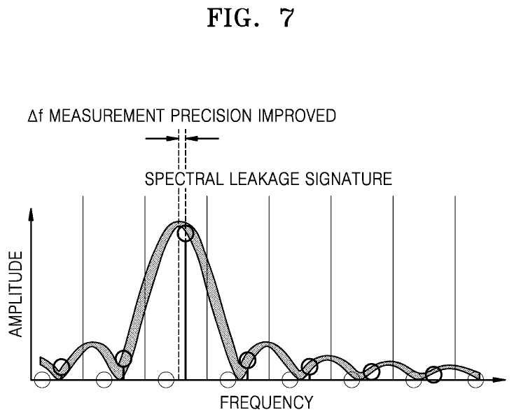

FIG. 7 is a graph of demodulating a sinc function graph of a frequency modulation tag received signal by using spectrum leakage feature points that display, in a frequency domain, a tag signal of a frequency modulation tag received by an FMCW radar of the present disclosure. The center frequency of the sinc function is the sum of a range frequency and a modulation frequency. By accurately removing the modulated frequency f_m using the method discussed above, the location of the communication device (frequency modulation tag) may be calculated.

The measured maximum peak signal of the intermediate signal of the communication device is expressed in 1/T Hz intervals, and thus may not be the exact f_r+f_m. The exact f_r+f_m is found by finding the center frequency of the sinusoidal function. In FIG. 7, a peak error frequency is indicated as df.

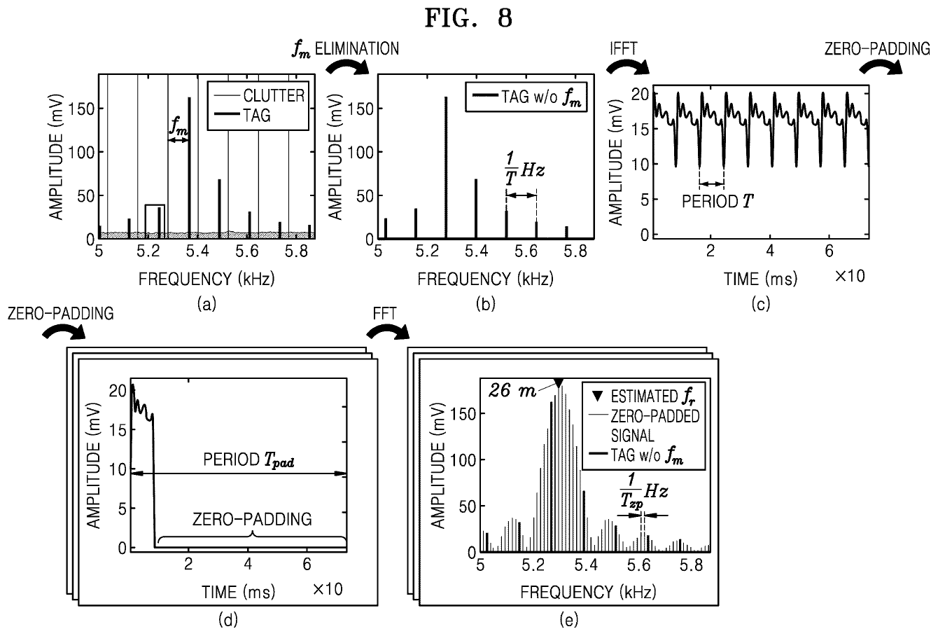

To solve the problem and measure locations more accurately, in the present disclosure, the spectral leakage characteristics of the discrete Fourier transform (DFT) for time-limited signals are used. The DFT of a signal with the period T and the frequency f_r is expressed as a peak at a multiple of 1/T Hz, and the envelope of the spectral leakage thereof is a sinc function centered at f_r. (i.e., TSinc(pi*T(f−fr))). Therefore, in order to accurately identify f_r, the envelope sink function is to be accurately identified. To this end, the location measurement method zero-pads a signal of duration T in the time domain to a size of T_pad. This is identical to sinc interpolation in the frequency domain. As shown in (c)-(e) of FIG. 8, the center of the sink function is located at f_r. As a result, when the sink interpolation result is given as in (e) of FIG. 8, f_r is obtained as a frequency with a maximum peak amplitude. The computational complexity of the overall location measurement method is O(N log N), where N is the number of samples, and the computational complexity thereof is the same as that of the FFT. That is, in the location tracking method, the complexity of the existing FMCW, which necessarily executes FFT, is maintained while achieving higher accuracy.

FIG. 8 is a diagram describing a sequence of signal processing of a tag signal of a frequency modulation tag received by an FMCW radar of the present disclosure. (a) After f_m is identified and removed in real time at the intermediate frequency (IF), (b) an IFFT (Inverse Fast Fourier Transform) is applied to a separated signal including only f_r (including spectral leakage). (c) In a time domain of the signal resulting from the IFFT, (d) a signal fragment of duration T is zero-padded, (e) where a FFT (Fast Fourier Transform) is performed to obtain an envelope sinc function, and f_r is computed as the frequency of the maximum peak amplitude.

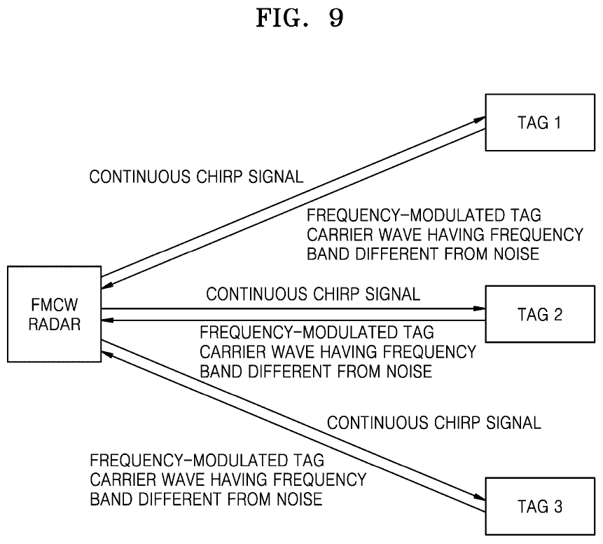

FIG. 9 is a conceptual diagram for measuring distances of a plurality of frequency modulation tags from an FMCW radar by using the FMCW radar and the plurality of frequency modulation tags of the present disclosure. Each tag (frequency modulation tag, communication device) signal has a different range frequency f_r and a different modulation frequency f_m, and an intermediate signal (IF) thereof is represented at different f_r+f_m frequencies.

The FMCW radar includes a wideband receiver (wideband receiving antenna) that analyzes a plurality of different tag intermediate signals (IF) in the frequency domain, thereby simultaneously measuring precise locations of tags that are independently represented at different frequencies depending on range and modulation frequencies. FIG. 9 explains this. The range frequency f_r is determined by a physical distance between a tag and the FMCW radar, and each tag is frequency modulated with a different modulation frequency f_m so that the tags are distinguished and the distance is measured.

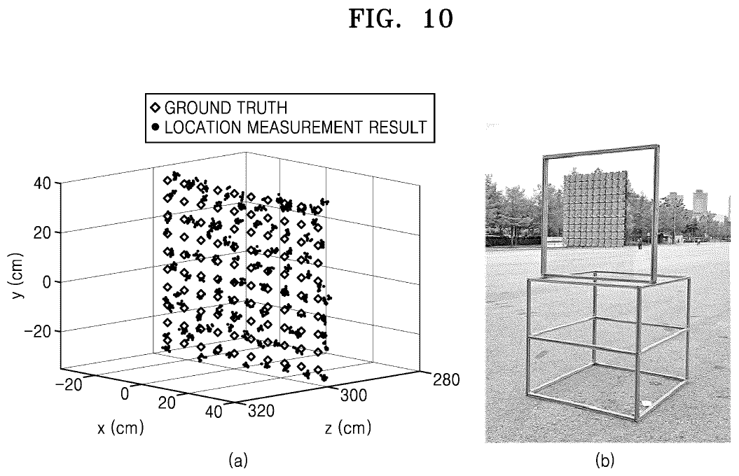

FIG. 10 is a diagram illustrating measurement of locations of a plurality of tags on a plane by using an FMCW radar and the plurality of frequency modulation tags of the present disclosure. The locations of the tags are measured very accurately. The result is not depicted by scanning tags one by one, but is depicted by having a plurality of tags arranged in two dimension simultaneously generate reflect waves in response to a transmission signal of the FMCW radar, receiving, by a wideband receiver of the FMCW radar, the generated reflect waves, converting the same to intermediate frequencies, recognizing each tag simultaneously in the frequency domain, and then calculating the distance by using the method described above.

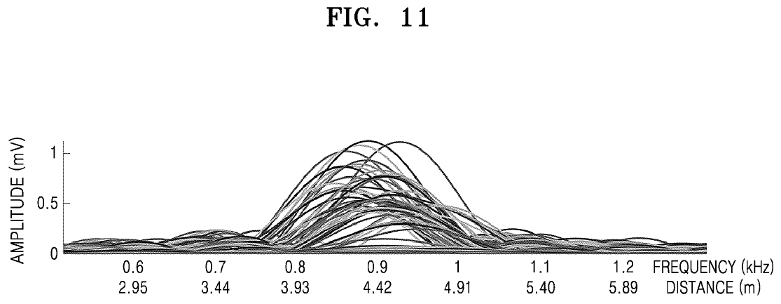

FIG. 11 is a graph showing results of calculating a sinc function of tag signals received from individual frequency modulation tags to measure locations of a plurality of tags on a plane by using an FMCW radar and a plurality of frequency modulation tags of the present disclosure. By accurately measuring the range frequency for each tag through the center frequency of the sinc function, the precise distance between the radar and the tag may be calculated.

According to the method of tracking a location of a communication device (tag, frequency modulation tag) of the present disclosure, a location of a stationary or moving communication device may be simultaneously tracked by a single FMCW radar transmission. This is a technique that is possible because each communication device is set to generate a different modulation frequency f_m. The different modulation frequencies f_m also function as ID (identifiers) that distinguish communication devices.

That is, the period 1/f_m of the modulation frequency of each communication device is set to be distinct from the period T of the FMCW radar transmission signal s(t). As a result, each communication device is effectively separated from the clutter as in FIG. 6, and may be represented by separate non-overlapping frequency peaks as in FIG. 11. According to the location tracking method, by including a wideband receiver, communication device signals having different FSK frequencies that return from multiple communication devices are obtained, and the intermediate signal (IF) thereof is analyzed in the frequency domain, thereby enabling to measure the accurate locations of communication devices independently represented at different frequencies according to range and modulation frequencies in the frequency domain. The f_m of each communication device may be set to a corresponding frequency interval to allow for the frequency error of the crystal oscillator used. Each f_m may include all frequencies that are not integer multiples of 1/T Hz, and their values may be lower or higher than 1/T Hz.

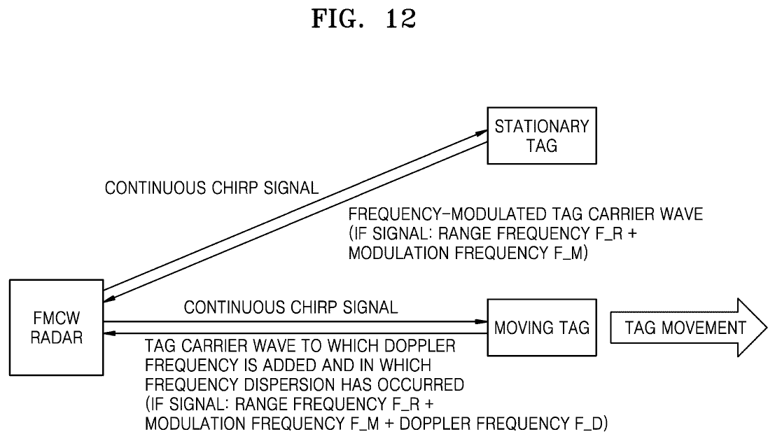

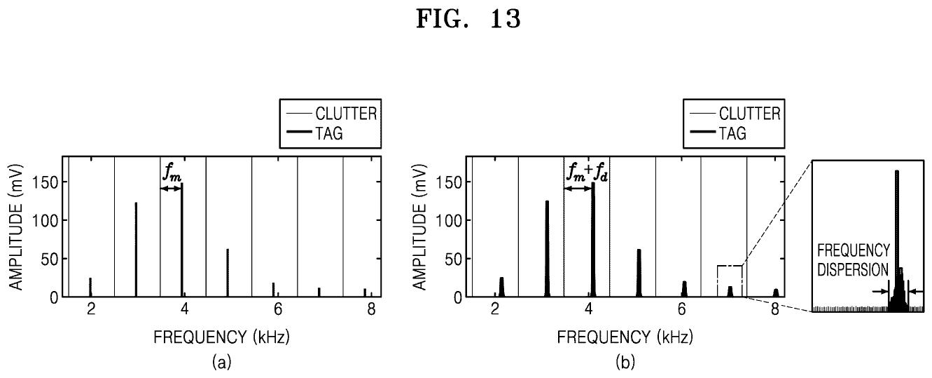

FIG. 12 is an explanatory diagram of a case where a frequency modulation tag is attached to a moving object and a case where a frequency modulation tag is attached to a stationary object, by using an FMCW radar and two frequency modulation tags of the present disclosure. Unlike stationary communication devices, moving communication devices induce a Doppler frequency f_d and a time-varying range frequency f_r(t). As the communication device moves, a Doppler frequency f_d is added on top of f_m. f_d essentially acts in the same way as f_m for the intermediate frequency (IF) signal, and is displayed apart from a peak of integer multiples of 1/T Hz, by f_m+f_d, instead of f_m. This may be easily removed by measuring the difference from the peak of a 1/T Hz integer multiple and shifting the IF signal by that frequency in a negative direction, similar to the f_m removal method described above. On the other hand, the range frequency f_r(t), which changes over time, causes frequency dispersion of the peak, as shown in FIG. 13(b).

Since the stationary frequency modulation tag does not have a variable element f_d, there is no frequency dispersion as shown in FIG. 13(a). This may be used to distinguish between moving and stationary tags.

The frequency dispersion increases as the movement of the communication device becomes faster. In the location tracking method, f_r(t) may be tracked with an accuracy of less than 1 centimeter through fine-grained temporal analysis. Through position measurement of a moving communication device, a moving communication device and a stationary communication device may be distinguished from each other through frequency dispersion proportional to the speed of the communication device. For sub-centimeter positioning, a moving communication device is defined as moving >1 cm within the duration of the FMCW radar transmission signal s(t), when peaks have a frequency dispersion greater than or equal to 1.4 Hz are defined as those.

In position measurement of a moving communication device, basically in the same manner as the design principles as for stationary communication device positioning, the mobile communication device signal f_m is removed, IFFT is performed ((a)-(c) of FIG. 8), and the range frequency (i.e., f_r(t)) is reconstructed in the time domain. That is, each signal fragment of f_r(t) (duration T) in (c) of FIG. 8 represents the location at the corresponding time, and zero padding is performed to represent the exact location at the corresponding time ((d) and (e) of FIG. 8).

By using the FMCW radar of the present disclosure, it is possible to observe frequency dispersion of a plurality of tag peaks to determine whether the tag is moving or stationary.

Additionally, it is possible to measure the moving speed of a tag by measuring the size of the frequency dispersion. To precisely track the location of the moving tag, the same location recognition process as that for a stationary tag is undergone. However, here, in order to precisely recover the change in location of the tag over time, IFFT may be performed by incorporating the tag peak, spectrum leakage, and its frequency dispersion in the process.

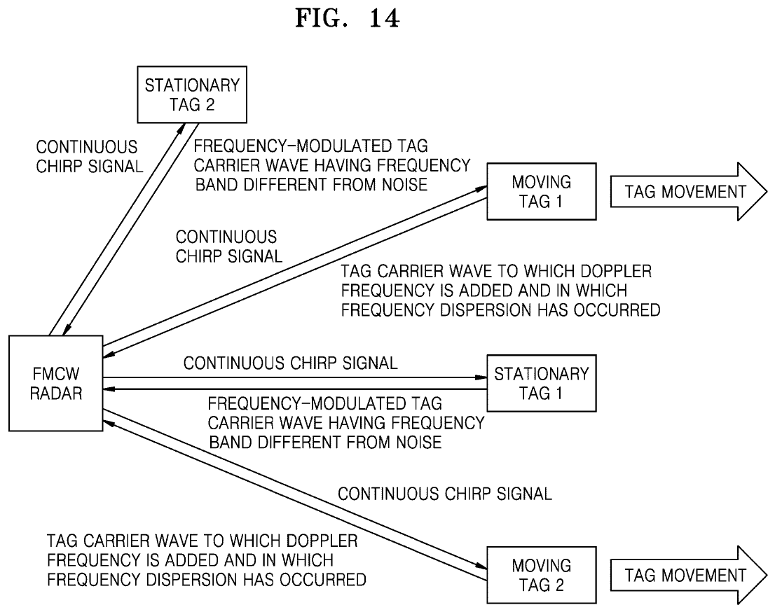

FIG. 14 is an explanatory diagram of a case where a frequency modulation tag is attached to a moving object and a case where a frequency modulation tag is attached to a stationary object by using an FMCW radar and a plurality of frequency modulation tags of the present disclosure. In a situation consisting of multiple moving tags and stationary tags, after distinguishing whether each tag is moving or stationary, location measurement is performed accordingly for classification. In this case, the wideband receiver of the FMCW radar may measure the locations of the multiple moving and stationary tags simultaneously.

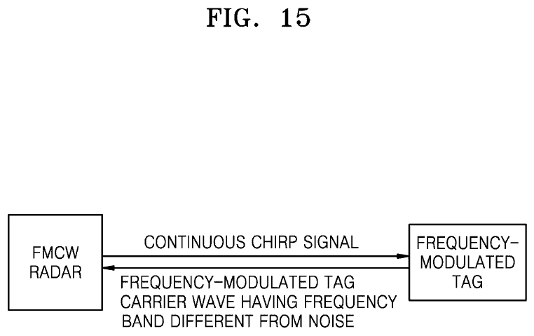

FIG. 15 is an explanatory diagram illustrating signals exchanged when measuring a distance between an FMCW radar and a frequency modulation tag by using the FMCW radar and one frequency modulation tag of the present disclosure. A one-dimensional distance may be measured using a single FMCW radar.

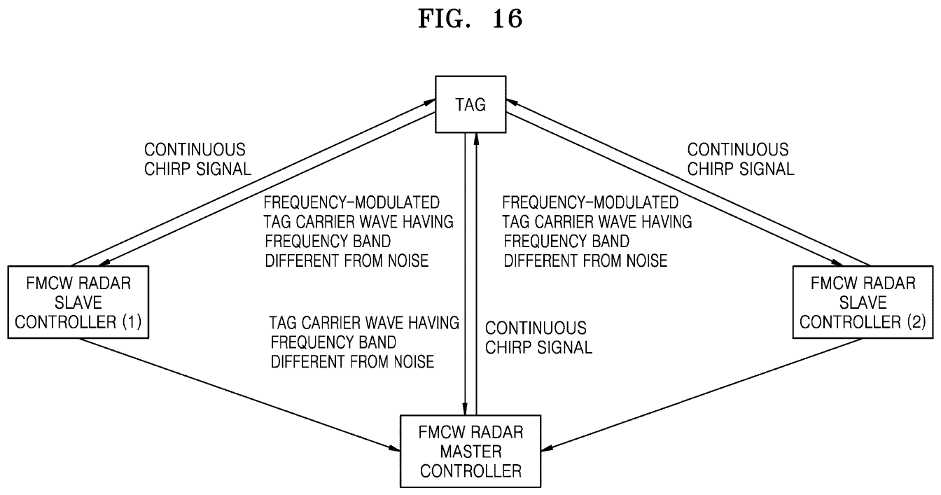

FIG. 16 is an embodiment for detecting a location of a frequency modulation tag in 2D or 3D space. By using two or more FMCW radars, the location of a tag in a plane or space may be calculated. To this end, a master FMCW radar and slave FMCW radars are provided, and each measured distance to the tag is transmitted to the master FMCW radar to determine the location of the tag in a plane or space.

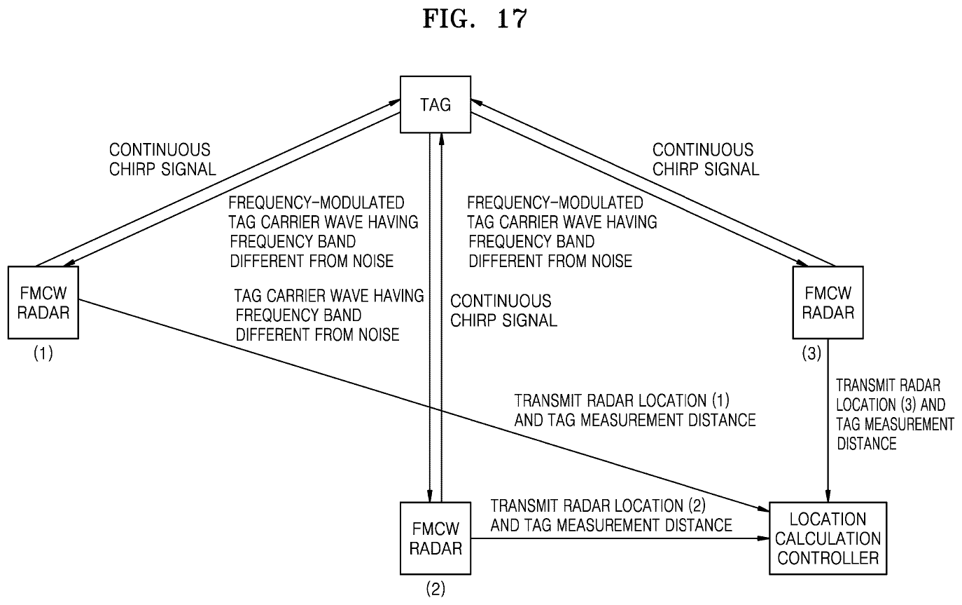

FIG. 17 is another embodiment for detecting a location of a frequency modulation tag in 2D or 3D space. A method is used to calculate the location of a tag by providing a separate location calculation controller without distinguishing between master and slave FMCW radars. Each radar may be connected to a controller, such as a mini PC or Raspberry Pi, that can post-process and transmit/receive radar information. The controller may transmit radar IF signals or measured distance information for each tag to the location calculation controller via wired or wireless communication, and may receive instructions from the location calculation controller to change continuous chirp signal settings (length per chirp and total number of chirps). The location calculation controller may display or store location information using information received from the radar, and instruct to change the continuous chirp signal settings according to environmental changes.

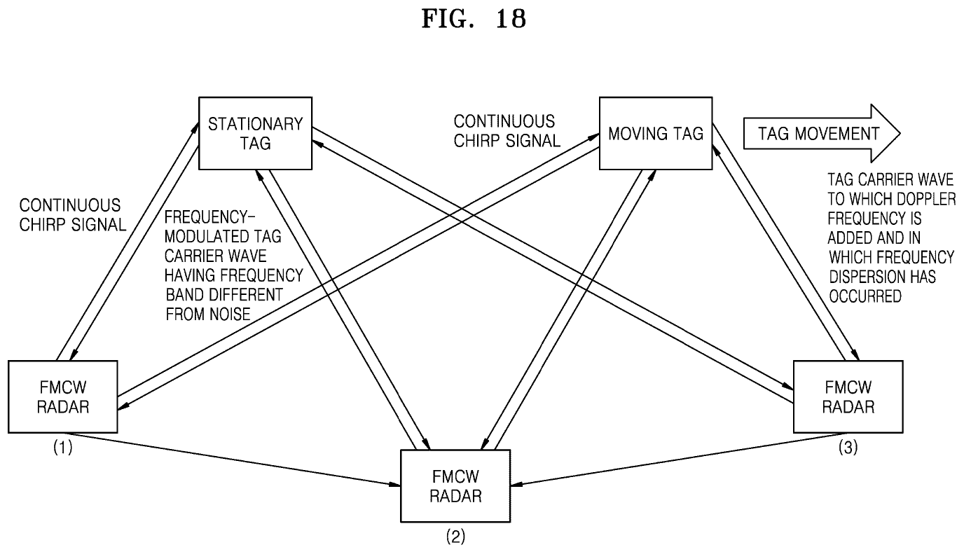

FIG. 18 is another embodiment of the present disclosure for simultaneously detecting a stationary frequency modulation tag and a moving frequency modulation tag in 2D or 3D space. This is also an explanatory diagram to explain that moving tags and stationary tags may be positioned in the same way, even when determining the location of a tag on a plane or in space. Tags that move in space may also be measured in the same way because their frequency dispersion is measured. The use of multiple radars for trilateration allows for simultaneous tracking of multiple stationary and moving tags. Here, moving tags are affected by different Doppler frequencies f_d for each radar depending on their direction of movement. To counter this, each radar may set an interval of the modulation frequency f_m and the range frequency f_r of each tag so as to respond to the maximum Doppler frequency.

### REFERENCE NUMERALS

100: location measurement system for communication devices by using FMCW radar
200: FMCW radar
210: Chirp signal generator
220: Signal Separator
230: Transmitting antenna
240: Receiving antenna
250: Signal mixer
260: Distance or location measurement algorithm
300: Communication device (frequency modulation tag)
310: Transmitting and receiving antennas
320: Modulation unit

### INDUSTRIAL APPLICABILITY

The disclosure of the present application is a technique that may be industrially applied as a method of measuring a location of a communication device using communication technology.

1. A location measurement system of a communication device using an FMCW radar, comprising:
an FMCW radar and a frequency modulation tag;
wherein the FMCW radar transmits, through a transmission antenna, a continuous chirp signal, and the frequency modulation tag receives the continuous chirp signal and reflects it by modulating the received frequency by f_m;
wherein the FMCW radar receives, through a receiving antenna, a signal reflected by the frequency modulation tag and calculates an intermediate signal (IF) by calculating the frequency difference between the transmitted continuous chirp signal and the received signal;
wherein the calculated intermediate signal is the sum of the modulation frequency f_m, modulated by the frequency modulation tag, and a range frequency f_r caused by a time shift due to the distance between the FMCW radar and the frequency modulation tag;
wherein, when the modulation frequency f_m of the frequency modulation tag is calculated from the intermediate signal, the range frequency f_r caused by the time shift due to the distance can be calculated;
wherein, when the continuous chirp signal transmitted through the transmission antenna of the FMCW radar is reflected by an ambient object other than the frequency modulation tag and received through the receiving antenna of the FMCW radar, the signals are periodically positioned in the frequency domain at frequencies which are integer multiples of the reciprocal of the unit chirp time period of the continuous chirp signal;
wherein the signal reflected by the frequency modulation tag is positioned in the frequency domain shifted by the modulation frequency f_m from the ambient reflection signals,
and wherein the frequency shift from the periodically appearing ambient reflection signals in the frequency domain is selected as the modulation frequency f_m.

2. A method of measuring a distance between an FMCW radar and a frequency modulation tag using the FMCW radar and the frequency modulation tag, the method comprising:
a radar transmission signal generation operation of generating, by the transmission antenna of the FMCW radar, a continuous chirp signal; and
a reflect wave transmission operation of receiving, by a tag receiving antenna provided in the frequency modulation tag, the continuous chirp signal generated in the radar transmission signal generation operation, modulating the frequency by f_m by a modulation unit provided in the frequency modulation tag, and transmitting the modulated signal by a tag transmission antenna of the frequency modulation tag; and
a signal receiving operation of receiving, by a receiving antenna provided in the FMCW radar, the modulated signal transmitted in the reflect wave transmission operation; and
a received frequency preprocessing operation of generating an intermediate signal by mixing the continuous chirp signal transmitted from the FMCW radar and the reflect wave signal received in the signal receiving operation to calculate the sum of the range frequency and the modulation frequency, which is the frequency difference between the transmitted continuous chirp signal and the received reflect wave signal; and
a frequency domain conversion operation of converting the intermediate signal generated in the received frequency preprocessing operation into the frequency domain; and
a separated frequency identification operation of identifying the ambient reflection signal frequency periodically located in the intermediate signal of the frequency domain, converted in the frequency domain conversion operation, and identifying the tag intermediate signal modulated by the frequency modulation tag; and
calculating the modulation frequency f_m by subtracting the frequency of the ambient reflection signal from the frequency of the tag intermediate signal modulated by the frequency modulation tag.

3. The method of claim 2,
wherein the continuous chirp signal generated by the FMCW radar comprises any one of a periodic repetition of two or more unit chirp signals, an intermittent periodic repetition of two or more unit chirp signals, a discontinuous periodic repetition of two or more unit chirp signals, and a discontinuous and intermittent periodic repetition of two or more unit chirp signals.
